(19) United States
(12) Patent Application Publication
(10) Pub. No.: US 2010/0083341 A1
(43) Pub. Date: Apr. 1, 2010

(54) Multiple Signal Output System and Technology (MSOST)

(76) Inventor: Hector Gonzalez, (US)

Correspondence Address: HECTOR GONZALEZ-MALDONADO, P. O BOX 371815, CAYEY, PR, 00737, US

(21) Appl. No.: 12/242,779

(22) Filed: Sep. 30, 2008

(51) Int. Cl. H04N 7/00

(52) U.S. Cl. 725/149

(57) ABSTRACT

The invention consists of a device, in the form of software or hardware, which converts a single audiovisual signal, with multiple components, to multiple signals transferred to different input devices. This Multiple Signal Output System and Technology is responsible of filtering a signal by virtual channels and separating images from the original source. The separation of the images can be outputted to different input devices using a variety of cables or similar technology. A videogame system can use the technology to separate multiplayer signals from one device to multiple screens or input devices. This invention solves the split-screen problem by giving the players the option to use one output device to play in multiple input devices. The Multiple Signal Output System and Technology separates in-software (in-movies, in-games) signals to output them to different devices. The technology can also capture different angles from an image (for example a movie) and output the separate signals to different input devices. With this technology, movies with multiple views and angles can be outputted to different devices simultaneously. Users can also watch movies, television, use the internet and play offline and online games simultaneously from the same output device and all the data is displayed simultaneously to different display screens or input devices. All these data can also be recorded by all the users simultaneously to the device using any storage solution. The invention uses standard cables, special cables and audiovisual wireless technology to output data to different display screens simultaneously.

### REFERENCE CITED

### U.S. Patent Documents

| | | |
|---|---|---|
| 4,740,779 | April 1988 | Cleary et al. |
| 5,275,565 | January 1994 | Moncrief |
| 5,361,078 | November 1994 | Caine |
| 5,367,614 | November 1994 | Bisey |
| 6,020,890 | February 2000 | Kohda |
| 6,190,172 | February 2001 | Lechner |
| 6,232,932 | May 2001 | Thorner |
| 6,501,441 | December 2002 | Ludtke et al. |
| 6,570,546 | May 2003 | Welker et al. |
| 6,661,425 | December 2003 | Hiroaki |
| 2002/0140628 | October 2002 | Morrone |
| 2003/0043087 | March 2003 | Kim |
| 7,091,926 | August 2006 | Kulas |

### BACKGROUND OF THE INVENTION

Conventional screen displays are used daily and are the input devices that translate the information coming from an output device. Many output devices are VCR's, DVD players, videogame systems, cable or satellite television. These output devices use a signal to send images information to the input device. The image could be a picture or a set of pictures, in the form of video. This signal is single and can only be completely outputted to one device.

Some unconventional screen displays exist. One of the approaches uses multiple display screens arranged in a rectangle or square form. The image is divided to separate screens forming one big image of a scene or video. This result in a larger image displayed through various smaller screen displays. Other unconventional screen displays uses many screens to display the same image in all of them. The same image can be outputted from the same source, but is also outputted from different sources. These types of systems typically use a computer to divide the principal image into different smaller images to complete a whole image.

Videogame systems output signals from a user to an input device or display (like a TV, monitor, etc.). The signal is translated into a moving image visible on the screen display. Typically one player uses the screen display for himself. Multiplayer games exist where users can play on the same videogame system and on the same screen, but the system separates images in a split-screen. This means that the game produces two or more variations of the same game, but displays them only in the same screen. Multiplayer games can also be played online or in a LAN connection, but requires another system or output device and another screen display. The invention claimed solves this problem.

When viewing motion pictures some systems use many displays organized around a room or person (for example IMAX). Many screens display the same image through the screens. The position of the screens can have different angles and these angles are recognized to produce an image for that screen. The same scene is not viewed at different angles, is displayed depending on the angle of a screen. A viewer cannot see a movie where he can see two screens, with different scenes or the same scene at different angles, at the same time. The invention claimed also solves this problem.

Conventional devices usually can only display one action at a time. A DVD player will be able to output a movie to the display screen and mostly that is the only thing the device can do at a time. Videogame devices can only display one game at a time; two users cannot be playing different games simultaneously from the same device. The invention claimed solves this problem by providing a device with the technology capable of outputting multiple signals at the same time.

A method to use one device to output multiple images to multiple displays is needed to improve the shortcomings of prior methods.

### SUMMARY OF THE INVENTION

The invention allows users to use one output device to produce different signals from the same source so that they can be outputted to different screen displays or input devices. More than one image or video signal can be produced in hardware or software of a device and then can be outputted to a display screen or to another input or display device. A stream of images can be separated using virtual channels and outputting them to different display devices. For example, videogame software can create two images on different virtual channels from two or more players, but with the invention they don't need to use split-screen to play, because they can play on two or more separate display screens from the same source.

The Multiple Signal Output System and Technology (MSOST) can be used on any output device, as hardware or software. DVD players, PC's, videogame systems and other output devices can use the invention to output multiple video or equivalent signals. Movies that can be viewed in the traditional way could be enhanced by the use of MSOST. MSOST could make a viewer with two or more display screens take advantage of the technology by connecting them to a MSOST output device. This way the user can watch movies with different scenes happening at the same time, in different displays, or the same scene in another place or angle, and could also control such angles and scenes. This will create a more interactive and innovative movie viewing experience.

The invention allows multiple entertainment and practical settings. A multiplayer section on the same game can be played on different displays. A play section in the same system with multiple players not playing the same game, but playing different games from the device can also be displayed. A player can be playing from a storage device (like a hard drive) and another player from a CD o DVD on the same system at the same time on different display devices. The invention allows multitasking procedures to be displayed in different input devices. Two users could be playing games while one user is watching movies, all from the same device simultaneously. All the signals could be outputted using cables, one special cable, or wireless audiovisual signals. The device with the technology invented can send audiovisual signals wirelessly to every display device capable of accepting it. One device could be the hub of all the entertainment or work in the same place. The device accepts more than one input, from different users, and computes all of them to display them on different input devices.

### BRIEF DESCRIPTION OF THE DRAWINGS

FIG. 1A shows an output device outputting several signals to different display screens or input devices with different cables;

FIG. 1B shows an output device, with the technology and system invented, outputting several signals to different display screens or input devices with only one cable;

FIG. 1C shows an output device, with the technology and system invented, outputting several signals to different display screens or input devices with an audiovisual wireless output technology;

FIG. 2A shows a user looking at two screens simultaneously, with different images (or movie scenes) coming from the output device with the technology invented;

FIG. 2B shows a user looking at two screens simultaneously, with different images (or movie scenes) with different angles each coming from the output device with the technology invented;

FIG. 3A shows two users playing a multiplayer game in the same device, but instead of playing in split-screen they play on two different screens with the signals separated by the invention;

FIG. 3B shows two users each playing different games being outputted to two display screens from the same device simultaneously;

FIG. 3C shows three users using the same output device with two playing games and one watching a movie, all of them on the same device simultaneously, but with different displays;

FIG. 3D shows three users connected to the internet (to play) and using the same output device with two playing games and one watching a movie, all of them on the same device simultaneously, but with different displays;

FIG. 4A shows five users, two playing games, one watching a movie, one using the internet and the other watching and recording television all on the same device simultaneously using different displays;

FIG. 4B shows five users each of them doing several things while recording their activities as two are playing games, one is watching a movie, one is using the internet and the other is watching television all on the same device simultaneously in different displays;

FIG. 5A shows five users with unconventional screen displays in a virtual reality or enhanced reality style, each of them doing a different activity from the same device.

### DETAILED DESCRIPTION OF A PREFERRED EMBODIMENT

The invention allows users to use an output device that can output multiple signals from the same source to various different displays. The invention technology is presently called Multiple Signal Output System and Technology (MSOST). The basis of the technology is the output of multiple signals (mostly several videos and not the same signal) from a device to be outputted to two or more input devices like screen displays simultaneously. A cable or set of cables, from the device with the invented technology, transfers the different signals or data from the device to several input devices. Different images or signals are separated by software or hardware using virtual channels or memory storage or similar technology. This separation allows the output device to send the different signals to different input devices. The signals are not from one image and are not a big image displayed through several screens. The signals come from different parts of a game (especially multiplayer) and movies. Display screens will not have the same image or parts of it, but a full other scene happening simultaneously to the principal one.

This set-up will change the way we watch movies and play games, because only one device can output entertainment for the whole family. The same device can output different games, movies and television shows to different display screens. This will change conventional uses for screens, videogames, movies, television, etc. A sample of a scenario using the device is that one user is playing a videogame while the other is watching a movie, both simultaneously from the same device. The following are more detailed explanations of the figures and the technology claimed.

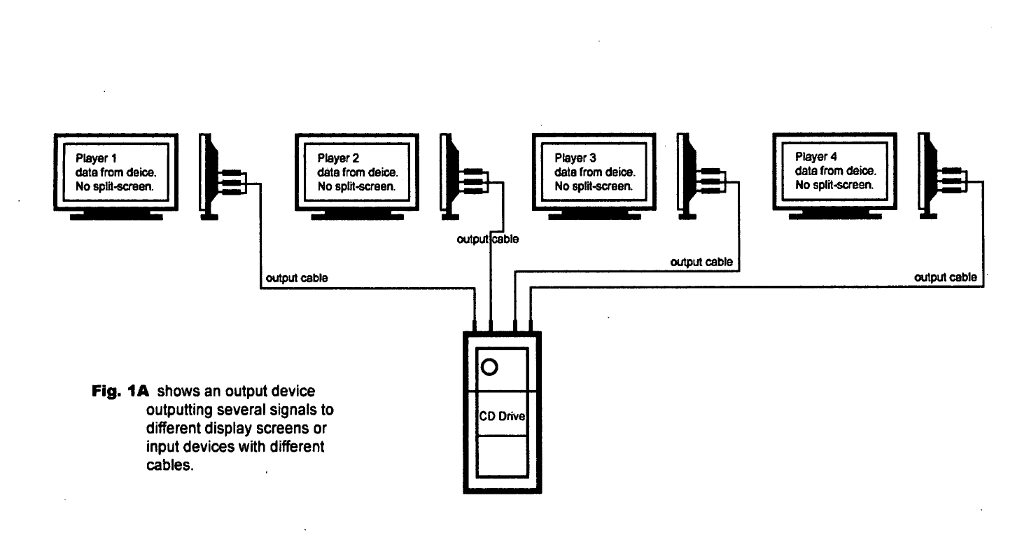

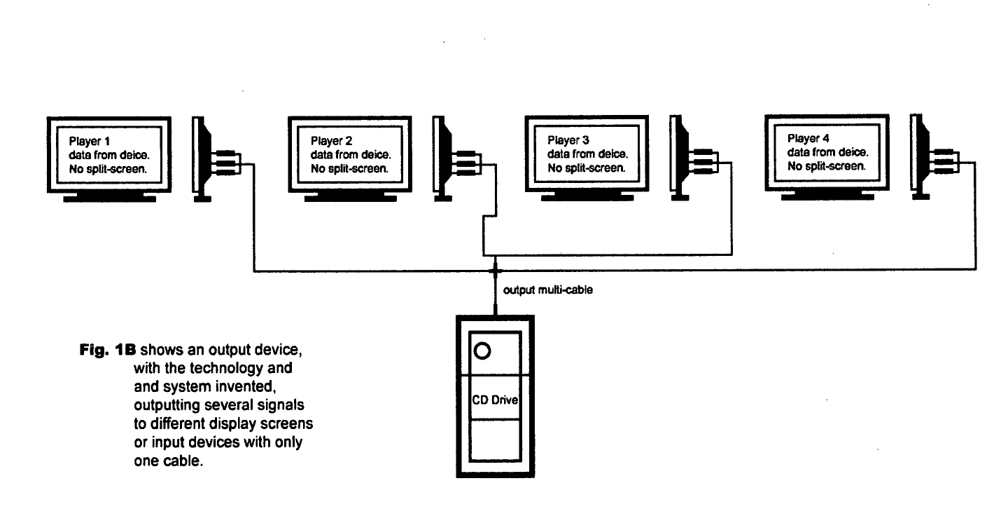

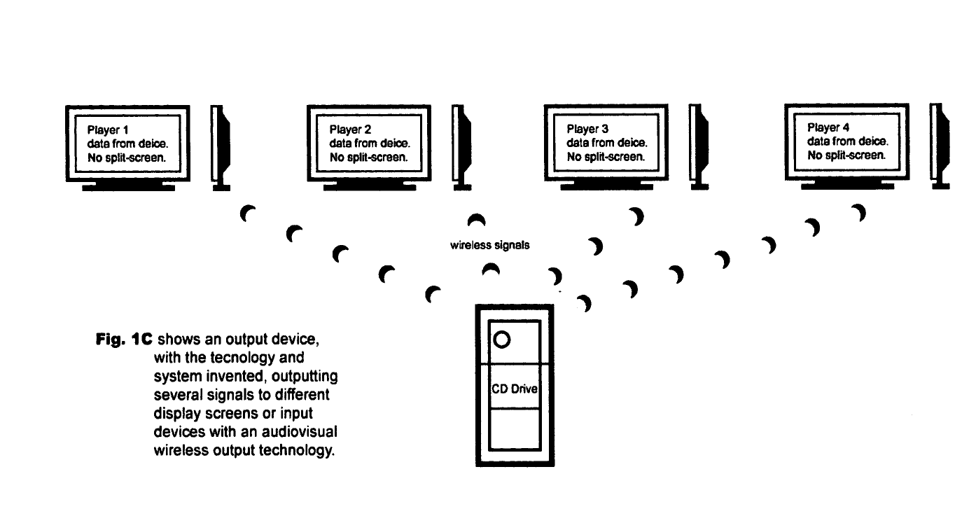

In FIG. 1A a user can see both screens at will. Different things should be happening on each screen. The same output device can have many types of cable inputs for output of the signals or it can do it wirelessly if the screen display is able to receive the signals. For example, the device can use AV cables, HDMI, VGA, DVI, component or any similar cable to display images in different input devices like screens. The device can use any combination of cables to output signals simultaneously to different devices or screen displays.

In FIG. 1B the user can use a special cable created for the invention. The special cable will separate the signals and output it to the screen displays. Only one cable is needed with this configuration of the invention. The cable has a defined format in comparison to HDMI but can be outputted to multiple devices. Each output signal is different, but comes from the same source.

In FIG. 1C the user uses the device to output audiovisual signals wirelessly to multiple display screens simultaneously. The technology invented is capable of sending multiple wireless audiovisual signals, from games, movies, etc. to different display screens. This means that one device can output audiovisual signals to multiple screens without the need of cables.

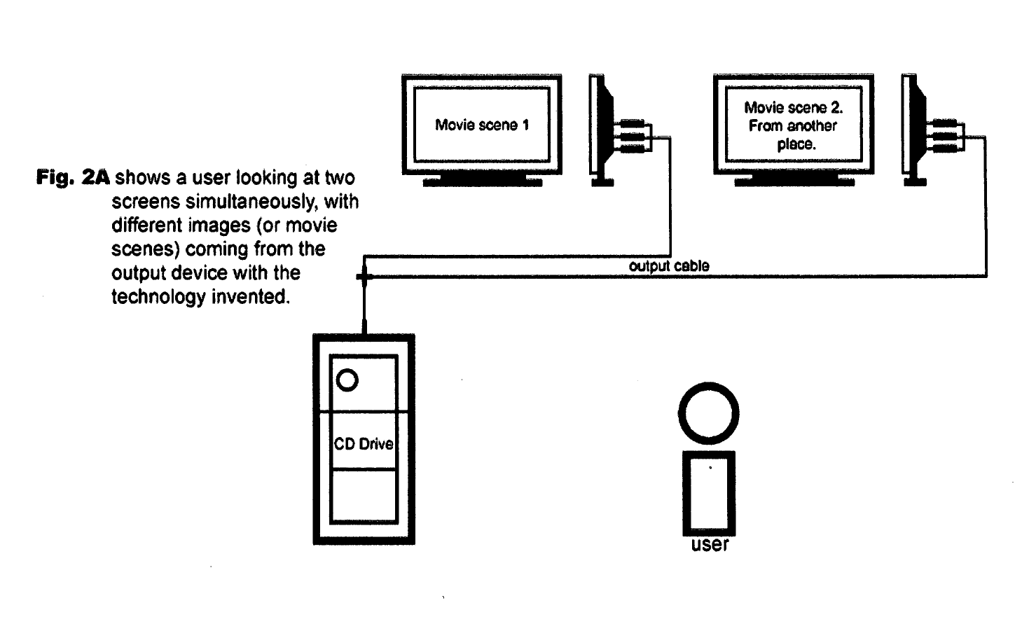

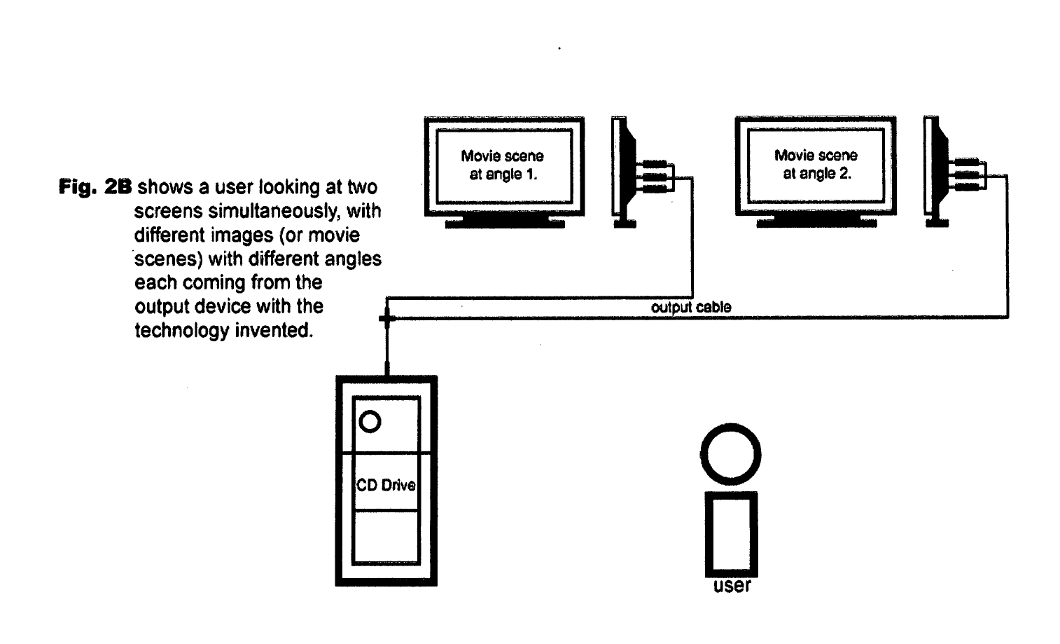

FIG. 2A is an output device with the technology invented (Multiple Signal Output System and Technology or MSOST) outputting different scenes of a movie, taking place at the same time, to different screen displays or input devices. A user or users can be watching a movie with the front screen been the principal one, but screens on the sides can be displaying images of other parts of the movie. Two things can be happening at the same time and place while the user is able to watch at will. Scenes can be at different angles or different scenes completely. The user can pause, fast forward, slow, rewind, etc. each scene individually.

FIG. 2B is an output device with the technology invented (MSOST) outputting different angles of a scene or scenes of a movie, taking place at the same time, to different screen displays or input devices.

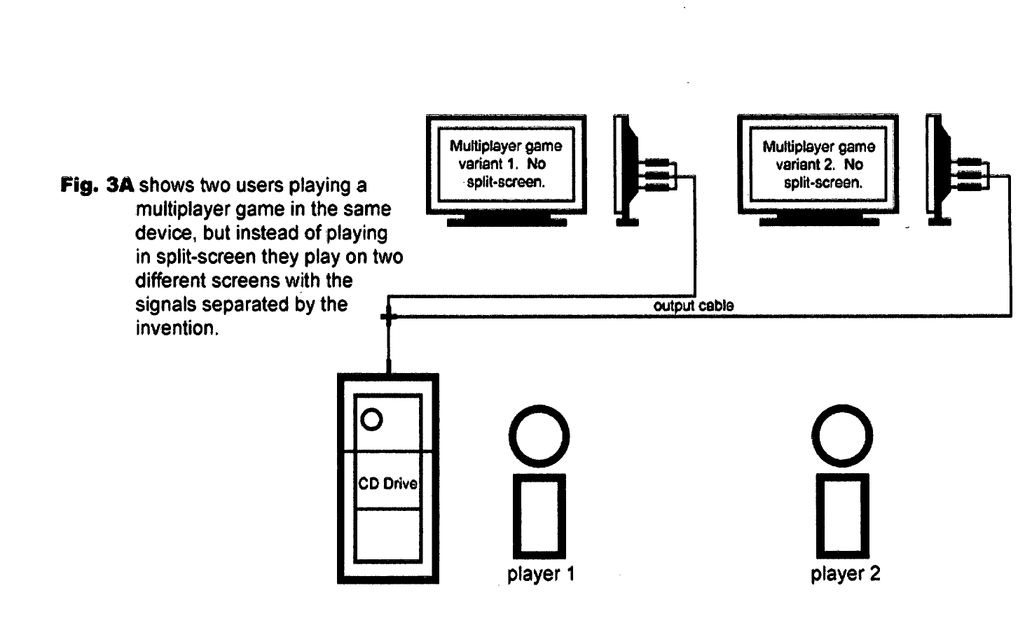

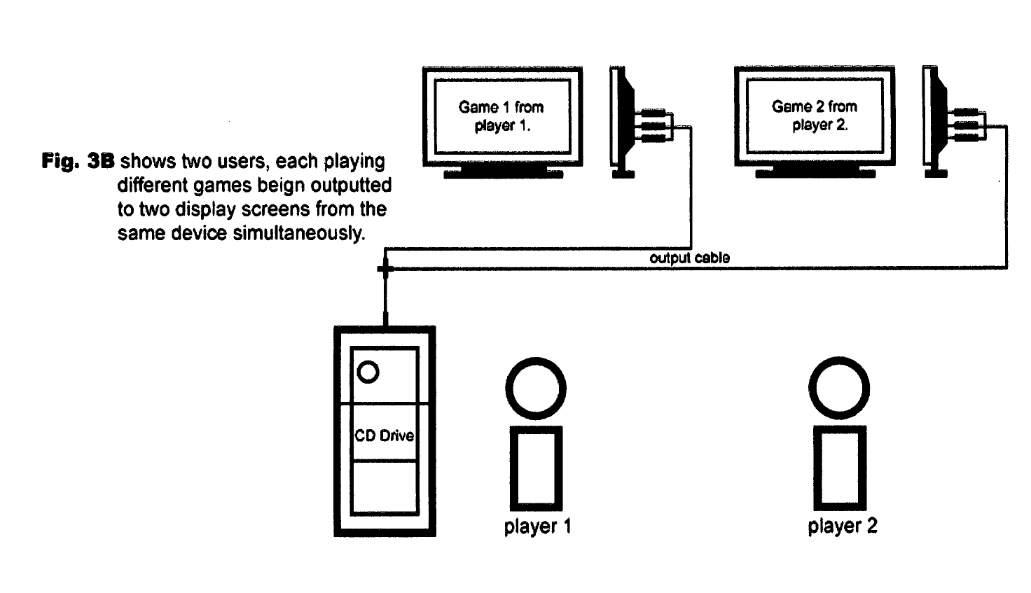

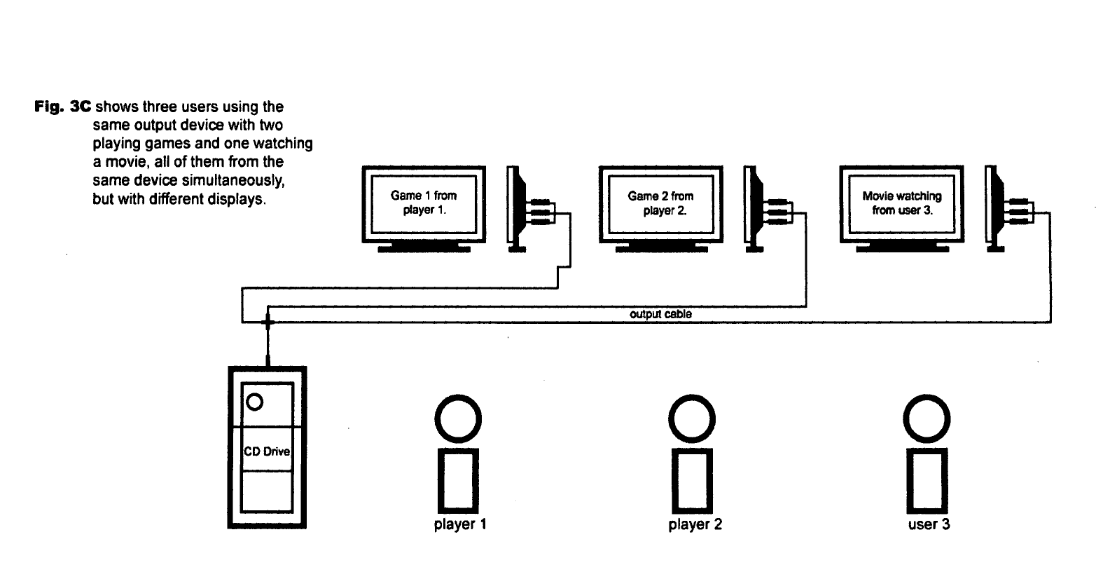

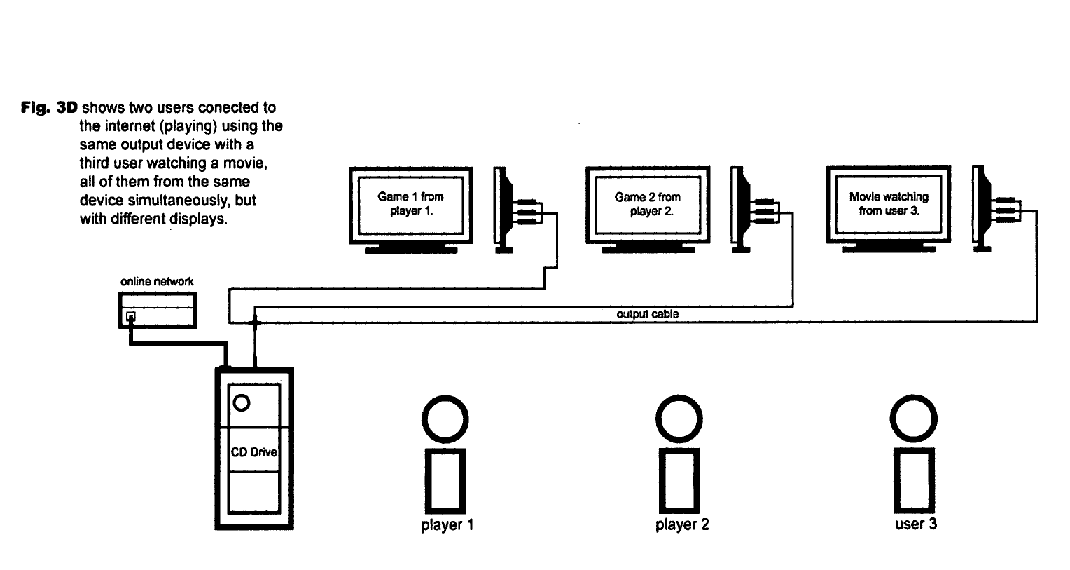

FIG. 3A is an output device with the technology invented (MSOST) outputting videogame multiplayer signals (normally in split-screen), taking place at the same time, to different screen displays or input devices; the images are separated by the invention and outputted to different screen displays. The same game with different variants can be outputted in all its components to different display screens. More than two players are able to play in different screens from the same device. They can play the same game or separate games simultaneously.

FIG. 3B is an output device with the technology invented (MSOST) outputting videogame signals from different games, taking place at the same time on the device, to different screen displays or input devices. Users are able to experience a variety of games from the same device simultaneously. This avoids the use of multiple videogame consoles on a household and makes room for one console to become the entertainment of the whole family.

FIG. 3C is an output device with the technology invented (MSOST) outputting videogame signals from different games and movies, TV or similar signals, taking place at the same time on the device, to different screen displays or input devices. Users can do more than gaming from the same device, they can also watch movies and TV simultaneously in different screen displays.

In FIG. 3D users are able to bring their multiple simultaneous experiences to an online space or virtual world. One user can play online games, while the other is playing offline games and another user is watching movies all of them outputted to different display screens or input devices simultaneously.

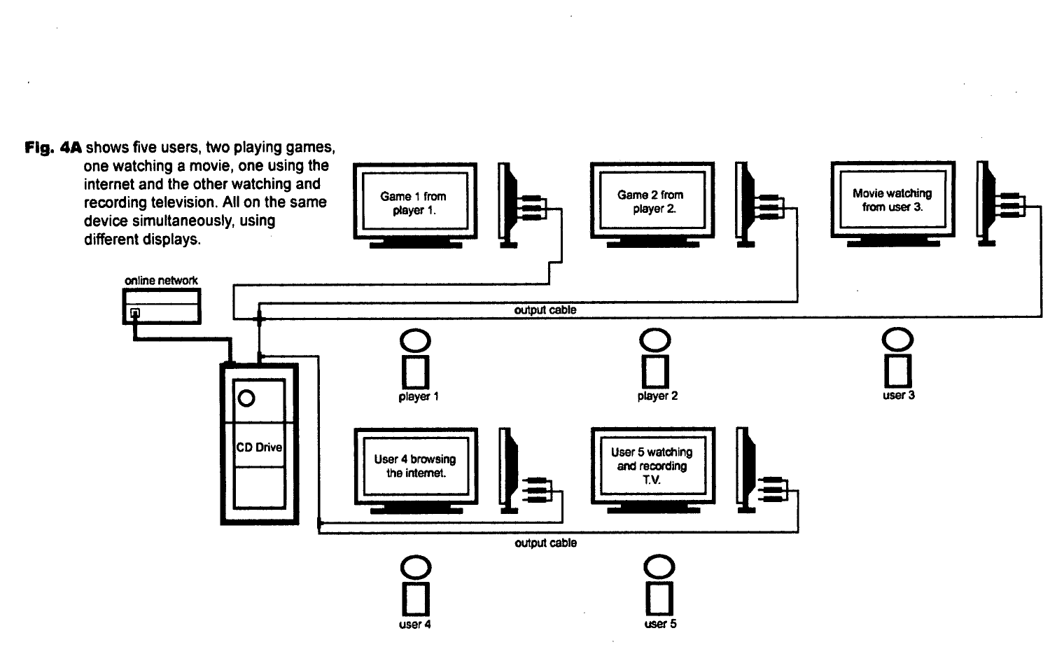

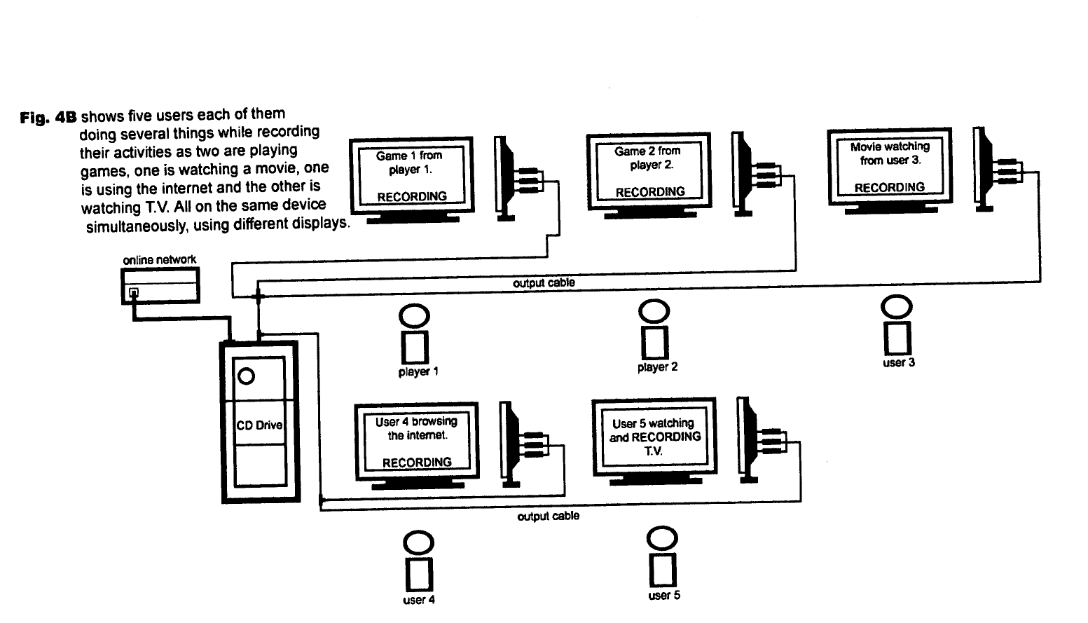

FIG. 4A is a variant of the technology where many users are enjoying games, movies and using the internet, but one of them is watching television and recording its programming to the device. All of these activities are accomplished by the same device with the technology invented (MSOST) and the actions can take place simultaneously and are outputted to different display devices or screens.

FIG. 4B is a variant where all the users enjoying games, movies, internet television, etc. can record to the device their action and the data been streamed to the different display screens simultaneously. This means that users can enjoy their games and record them as well as movies or TV shows.

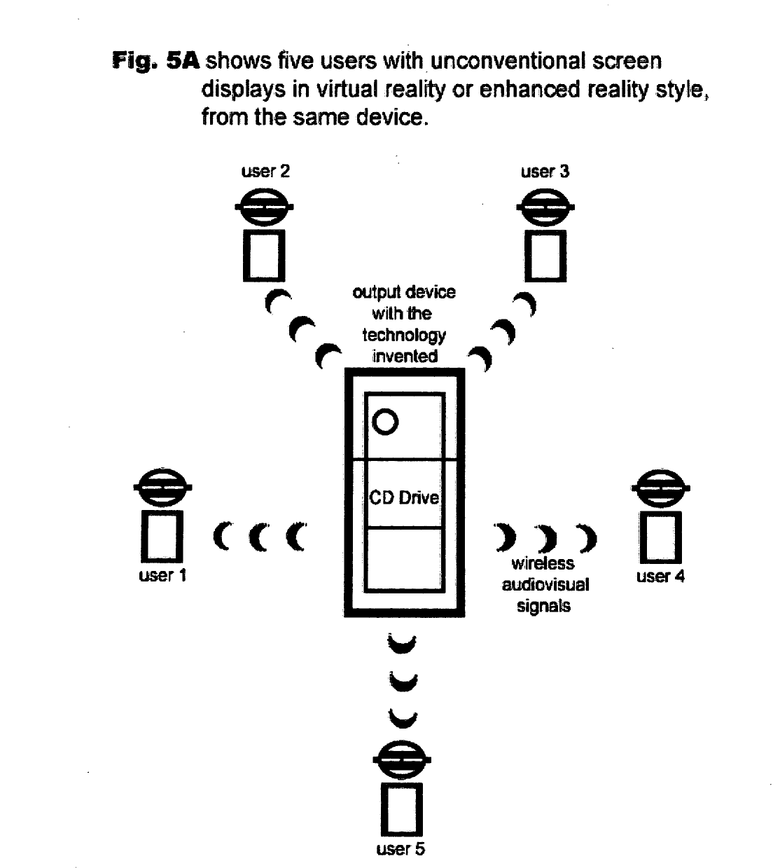

FIG. 5A is a variant of the technology were the users use unconventional screen displays or output devices. The same device can output signals to smaller screen displays like virtual reality or enhance reality headsets, which are essentially multiple display screens. Each of the display screens can output all the activities mentioned before in an individual manner.

The invention claimed is:

1. The Multiple Signal Output System and Technology (MSOST or the invention) consists of a device capable of converting a single signal, with multiple components, into multiple signals from the same source; the converted multiple signals can be outputted to more than one output reader or input device simultaneously showing different images in each device from the same source, but not the same image.

2. The method of claim 1, wherein the multiple outputs come from the same image or set of images (frames) and are not a big image of a single signal in many input devices or displays.

3. The method of claim 1, wherein the signal can be outputted from the same source, but with different characteristics each; like for example, the user can watch movies with different scenes happening at the same time, in different displays, or the same scene in another place or angle.

4. The method of claim 3, wherein when watching one scene, the user can actually see the same scene in the same time frame at different angles; this technology allows movies (or games) with multiple views and angles to be outputted to different devices simultaneously and they can control the timing individually (or as a whole) of each scene (rewind, fast forward, etc.).

5. The method of claim 4, wherein the user may control the set of scenes and angles of each different input device, via a virtual camera around the scene; angles and output could be controlled via hardware or software and interpreted by a device with MSOST to output the multiple signals.

6. An input device that accepts the output of MSOST, software or hardware, is the only device capable of using the input from a MSOST device and accepts all the signals in one device.

7. The MSOST could be used in any image or multi-frame outputting device to multitask many procedures simultaneously; for example, a videogame system could output the signal of different games or movies (from different storage devices like or similar to a hard drive, internet connection, satellites and CD or DVD) in the same device to different input devices and screen displays.

8. The method of claim 7, wherein the MSOST recognizes a game from a videogame device and can output images from different players in the same or different games (or other data from an storage device like a hard drive) to different input devices (like TV's).

9. The method of claim 8, wherein instead of a split-screen multiplayer game or a LAN connection with different systems, only one system or output device can recognize players data to output a single player or multiplayer session of each player to individual input devices (like TV's or monitors).

10. The method of claim 9, wherein a device using MSOST could be able to connect to the internet and bring every user to an online experience.

11. The MSOST is made of cables, computer chips (hardware) and a computer system or program (software) that recognizes the signals and can output them to different input devices (using virtual channels or other technology).

12. The method of claim 11, wherein the MSOST can be used in an output device outputting signals with different set of cables and input connections from the same device or can output audiovisual signals wirelessly.

13. The method of claim 12, wherein one MSOST cable can also output multiple signals without the need of extra connections to the output device or can output every audiovisual signal wirelessly to a capable input device or devices.

14. The method of claim 13, wherein the MSOST cable has one connection to the output device and multiple AV, component, VGA, DVI, HDMI or equivalent connections to be able to connect to different input devices.

15. The MSOST can use multiple virtual channels or storage (like hard disk) to separate the signals, from the same source, before output and then move this signal from the virtual channels to the input devices using a cable or audiovisual wireless technology.

16. The method of claim 15, wherein the signals are filtered as separate from the same source and are outputted through the corresponding cables, wireless output or similar technology.

17. The method of claim 16, wherein a special type of software can have a code or program, on a CD, DVD or similar technology, capable of using MSOST.

18. The method of claim 17, wherein more than one image or video signal can be produced in hardware or software of a device and then can be outputted to a display screen and/or to another input or display device.

19. The invention accepts more than one input, from different users, and computes all of them to display them on different input devices simultaneously.

20. The invention is capable of recording (in hard drive or similar technology) every user data and activity taking place; for example, a player can record or play a game, while his father could be recording or watching a movie from the television, simultaneously.
